(19) United States
(12) Patent Application Publication
(10) Pub. No.: US 2019/0121561 A1
(43) Pub. Date: Apr. 25, 2019

(54) REDUNDANT STORAGE SYSTEM AND FAILURE RECOVERY METHOD IN REDUNDANT STORAGE SYSTEM

(71) Applicant: HITACHI, LTD., Tokyo (JP)

(72) Inventors: Naoya OKAMURA, Tokyo (JP); Masanori FUJII, Tokyo (JP)

(73) Assignee: HITACHI, LTD., Tokyo (JP)

(21) Appl. No.: 16/123,587

(22) Filed: Sep. 6, 2018

(30) Foreign Application Priority Data
Oct. 24, 2017 (JP) 2017-205507

(51) Int. Cl. G06F 3/06; G06F 11/20

(52) U.S. Cl. CPC G06F 3/0635; G06F 3/0614; G06F 3/0683; G06F 11/2005; G06F 3/0653

(57) ABSTRACT

A plurality of controllers continuously perform by degenerating communication between the controllers by using a portion of the controller communication path even when it is determined that one controller among the plurality of controllers is to be blocked, while, when it is determined as a result of the block determination that the one controller is to be blocked but the block determination is erroneous, the new controller is synchronized to the reinstalled one controller by using the most recent system control information which was last synchronized, in response to the new controller being installed in place of the one controller.

### TECHNICAL FIELD

The present invention relates to a redundant storage system and a failure recovery method in the redundant storage system, and more particularly can be suitably applied to a redundant storage system in which a plurality of controllers are interconnected via controller communication paths.

### BACKGROUND ART

Typically, when a failure occurs in any controller, a redundant storage system may pass into a state where it cannot be determined which controller has failed and induced overall system failure (hereinafter called ‘failure mode’). In such a failure mode, either controller must be blocked by being blindly singled out. Here, even if one normal controller is reinstalled after this one controller was erroneously blocked and removed provisionally, because a log update will have progressed in the other controller, synchronization between both controllers is not possible and the system cannot be recovered. Therefore, in a conventional redundant storage system, ultimately the other controller in which failure was generated will have to be replaced in an offline state (hereinafter called ‘offline replacement’) (see PTL 1, for example).

Moreover, in the redundant storage system, to ensure transmission line quality as the controller communication paths between the plurality of controllers grow in length, a driver circuit, adopted as a low-end model, is sometimes provided.

### CITATION LIST

### Patent Literature

[PTL 1] Japanese Laid-Open Patent Application Publication No. 2015/84144

### SUMMARY OF THE INVENTION

### Problems to be Solved by the Invention

However, in a conventional redundant storage system, there is a risk that such breakdown of the driver circuit itself will raise the breakdown rate (FIT rate) of the whole system. More particularly, a driver circuit using a device which implements a high-speed transmission line protocol requires a logic circuit design, and the circuit configuration tends to be complex, and hence the fault generation rate is high, which contributes to failure arising between the plurality of controllers. As a result of the foregoing, the aforementioned offline replacement becomes necessary, and there is a risk of a whole system stoppage.

The present invention was devised in view of the foregoing points, and an object of this invention is to propose a redundant storage system and failure recovery method in the redundant storage system which, when failure is generated, allow the accuracy of determining whether a controller among a plurality of controllers is to be blocked to be improved, while enabling a controller to be once again safely replaced even when a determination of which controllers are to be blocked has failed, thereby minimizing the risk of a whole system stoppage.

### Means to Solve the Problems

In order to achieve the foregoing object, in the present invention, a redundant storage system comprises a plurality of controllers which control each of a plurality of storage apparatuses, the plurality of controllers being connected via a controller communication path, wherein the plurality of controllers each comprise a failure information gathering unit which gathers failure information relating to failure generated in the plurality of controllers or in any part between the plurality of controllers, an information synchronization unit which causes the failure information gathered by the failure information gathering unit and system control information relating to control of the plurality of controllers to be synchronized and shared between the plurality of controllers, a block determination unit which performs a block determination of which controller among the plurality of controllers is to be blocked when it is detected that failure has been generated in the plurality of controllers or in any part between the plurality of controllers based on the failure information which was last synchronized by the information synchronization unit; a degeneration control unit which continuously performs by degenerating communication between the plurality of controllers by using a portion of the controller communication path even when it is determined that one controller among the plurality of controllers is to be blocked, and a resynchronization instruction unit which, when it is determined as a result of the block determination that the one controller is to be blocked but the block determination is erroneous, causes the information synchronization unit to synchronize the new controller to the reinstalled one controller by using the most recent system control information which was last synchronized, in response to the new controller being installed in place of the one controller.

Moreover, in the present invention, a failure recovery method in a redundant storage system which comprises a plurality of controllers which control each of a plurality of storage apparatuses, the plurality of controllers being connected via a controller communication path comprises a failure information gathering step in which the plurality of controllers gather failure information relating to failure generated in the plurality of controllers or in any part between the plurality of controllers, an information synchronization step in which the plurality of controllers cause the failure information gathered in the failure information gathering step and system control information relating to control of the plurality of controllers to be synchronized and shared between the plurality of controllers, a block determination step in which one controller among the plurality of controllers performs a block determination of which controller among the plurality of controllers is to be blocked when it is detected that failure has been generated in the plurality of controllers or in any part between the plurality of controllers based on the failure information which was last synchronized in the information synchronization step, a degeneration control step in which the plurality of controllers continuously perform by degenerating communication between the plurality of controllers by using a portion of the controller communication path even when it is determined that one controller among the plurality of controllers is to be blocked, and a resynchronization instruction step in which, when it is determined as a result of the block determination that the one controller is to be blocked but the block determination is erroneous, one controller among the plurality of controllers causes the new controller to be synchronized to the reinstalled one controller by using the most recent system control information which was last synchronized in the information synchronization step, in response to the new controller being installed in place of the one controller.

### Advantageous Effects of the Invention

According to the present invention, when failure is generated, the accuracy of determining whether a controller among a plurality of controllers is to be blocked is improved, while enabling a controller to be once again safely replaced even when a determination of which controllers are to be blocked has failed, thereby minimizing the risk of a whole system stoppage.

### BRIEF DESCRIPTION OF DRAWINGS

FIG. 1 is a block diagram showing a schematic configuration of a redundant storage system according to a first embodiment.

FIG. 2 is a block diagram showing a configuration example of the driver circuit shown in FIG. 1.

FIG. 3 shows an example of an error log of the controller communication path shown in FIG. 1.

FIG. 4 is a flowchart showing an example of the failure recovery method according to the first embodiment.

FIG. 5 is a sequence chart showing an example of degeneration linkup processing when the apparatus is started.

FIG. 6 is a sequence chart showing an example of degeneration linkup processing when the apparatus is operating.

FIG. 7 is a sequence chart showing an example of faulty controller specification processing using failure information.

FIG. 8 is a sequence chart showing an example of processing which specifies a block target controller.

### DESCRIPTION OF EMBODIMENTS

An embodiment of the present invention will now be explained in detail with reference to the appended drawings.

### (1) First Embodiment

(1-1) Configuration of Redundant Storage System According to the First Embodiment.

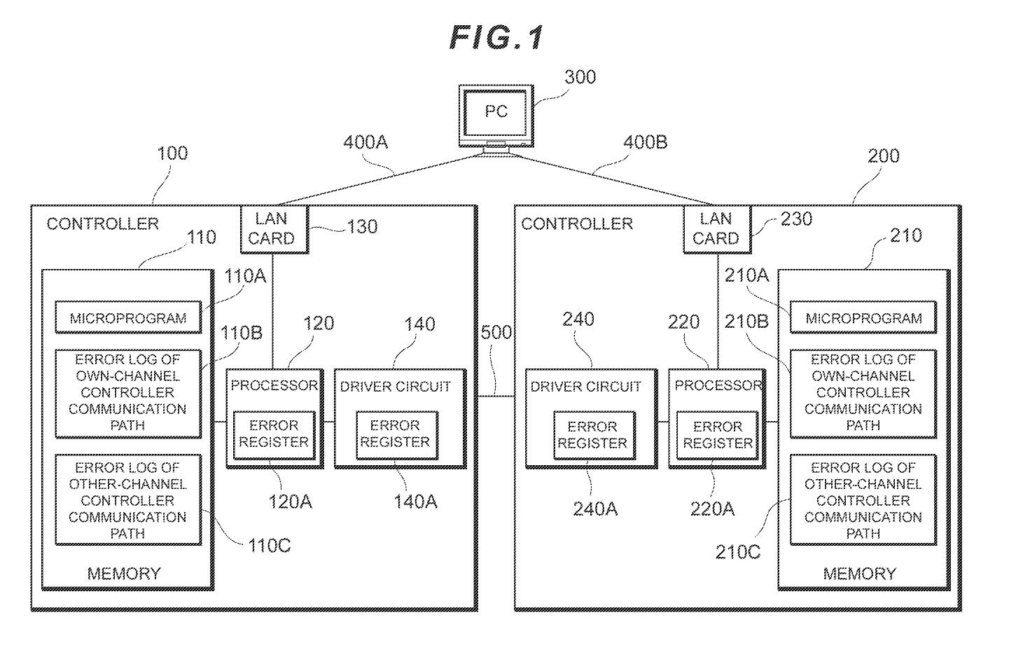

FIG. 1 shows a schematic configuration of a redundant storage system according to the first embodiment.

The redundant storage system according to the first embodiment comprises a first controller 100 and a first storage apparatus which is not shown, a second controller 200 and a second storage apparatus which is not shown, and a PC 300. The first controller 100 is connected to the PC 300 via a LAN card 130 by means of a network 400A, whereas the second controller 200 and PC 300 are connected via a LAN card 230 by means of a network 400B.

The PC 300 is a computer that is operated by a maintenance worker and which outputs instructions to write and read data to the first controller 100 and the second controller 200 according to an operation by the maintenance worker.

The first controller 100 controls the reading and writing of data from/to the first storage apparatus according to instructions received from the PC 300, whereas the second controller 200 controls the reading and writing of data from/to the second storage apparatus according to instructions received from the PC 300.

The first controller 100 and the second controller 200 are connected by means of a controller communication path 500 which is configured from a plurality of lanes, and various information such as failure information indicating failure and system control information, which are described hereinbelow, can be exchanged using communications via the controller communication path 500.

In the redundant storage system, the first controller 100 is configured in much the same way as the second controller 200 and the first storage apparatus is configured in much the same way as the second storage apparatus.

That is, the first controller 100 comprises a memory 110 which stores a microprogram 110A, an own-channel error log 110B of the controller communication path and an other-channel error log 110C of the controller communication path 500, and a processor 120 which comprises an error register 120A, and by way of an example, further comprises a driver circuit 140 which comprises an error register 140A. The error register 120A stores error information which indicates failure in the controller communication path 500 at startup time and periodically, for example, whereas the error register 140A stores error information which indicates failure of the driver circuit 140 at startup time and periodically, for example.

Meanwhile, the second controller 200 corresponds to each configuration of the first controller 100 and comprises a memory 210 which stores a microprogram 210A, an own-channel error log 210B for the controller communication path 500 and an other-channel error log 210C for the controller communication path, and a processor 220, which comprises an error register 220A, and by way of an example of a part in which failure readily occurs, further comprises a driver circuit 240 which comprises an error register 240A. Note that the error register 220A is used to store error information which indicates failure in the controller communication path, whereas the error register 240A is used to store error information which indicates failure of the driver circuit 240. In the ensuing explanation, the first controller 100 will mainly be explained, and an explanation of the second controller 200, which has the same configurations, is omitted.

The driver circuit 140 is an example of a part in which a failure occurs between the first controller 100 and the second controller 200. The driver circuit 140 comprises an error register 140A which stores information relating to failures that have been generated as an error log.

According to the first embodiment, the generation of failure between the first controller 100 and the second controller 200 is not limited to the driver circuit 140 which is shown by way of an example, rather, there may be cases of failure generation in at least one part among the plurality of lanes constituting the controller communication path 500, for example. The first embodiment establishes whether at least a portion of the lanes among the plurality of lanes are communication-capable, even when failure is generated.

As explained in the foregoing, the processor 120 comprises an error register 120A which is written with the same error log as the error log stored in the error register 140A of the aforementioned driver circuit 140.

In the memory 110, the microprogram 110A operates under the control of the processor 120. The microprogram 110A stores information, which is gathered in its own controller (the first controller 100) and which relates to failure that is generated in the communication path between its own controller and the other controller (the second controller 200), as an error log 110B in the memory 110. However, the microprogram 110A stores information, which is gathered in the other controller (the second controller 200) and which relates to failure that is generated in the communication path between the other controller and its own controller (the first controller 100), as an error log 110C in the memory 110. Note that, it goes without saying that the second controller 200 has a configuration which is the reverse of the configuration explained in relation to the first controller 100 hereinabove.

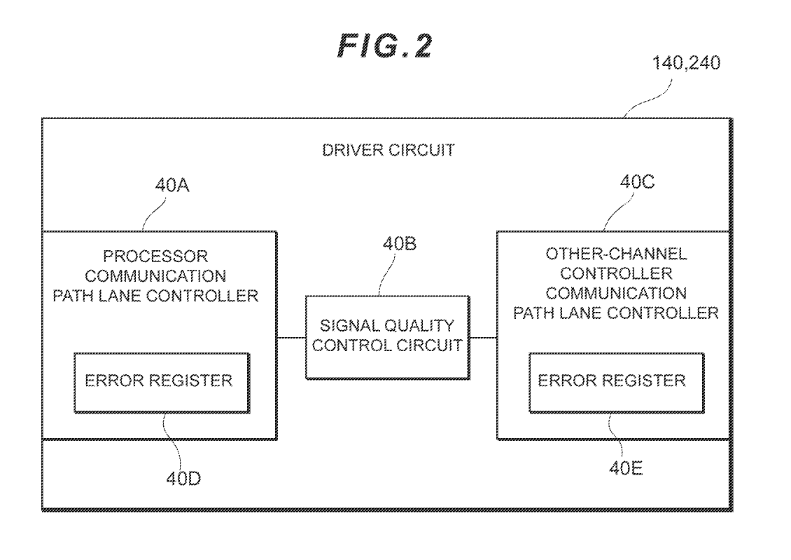

FIG. 2 shows a configuration example of the driver circuit 140 shown in FIG. 1. The driver circuit 140 comprises a processor communication path lane controller 40A, a signal quality control circuit 40B, and an other-channel controller communication path lane controller 40C. Note that ‘own channel’ denotes a controller which is on its own side when taking a certain controller among the plurality of controllers 100, 200 as a reference, and ‘other channel’ denotes the controller on the partner side when taking a certain controller among the plurality of controllers 100, 200 as a reference.

The other-channel controller communication path lane controller 40C controls communications using a plurality of lanes which constitute the controller communication path 500 that is present between the own controller (the first controller 100) and the other controller (the second controller 200).

The processor communication path lane controller 40A controls communications, using the plurality of lanes which constitute the communication path, with the processor 120.

The signal quality control circuit 40B is a circuit that is provided in any position of an internal path, and which improves the signal quality by implementing error correction of signals exchanged using the internal path, and the like.

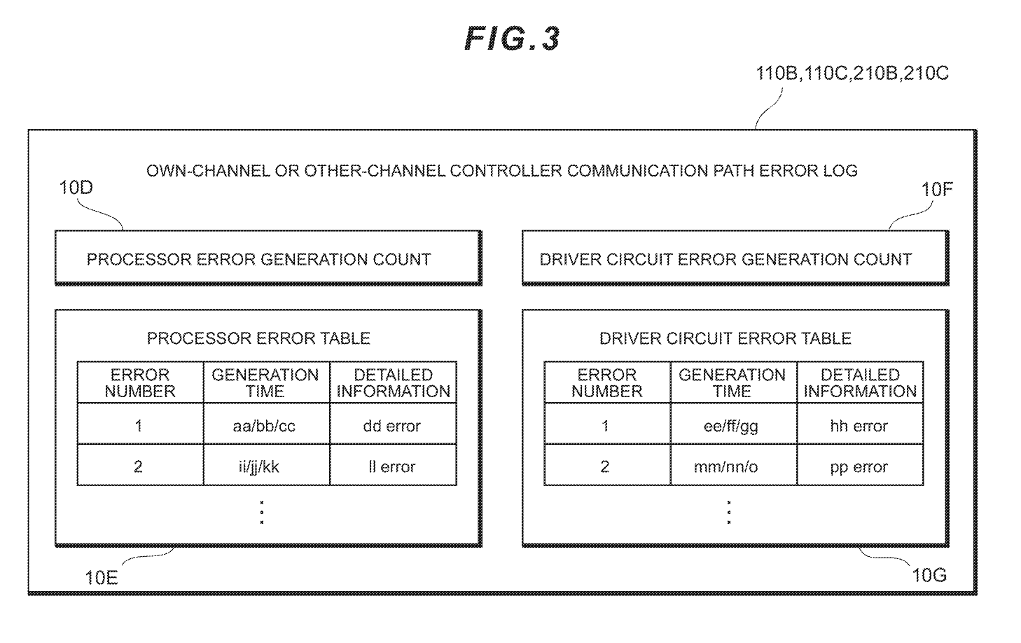

FIG. 3 shows an example of the own-channel controller communication path error logs 110B and 210B and the other channel controller communication path error logs 110C and 210C shown in FIG. 1. Note that the own-channel controller communication path error logs 110B and 210B and the other channel controller communication path error logs 110C and 210C have the same configuration, and hence hereinafter the own-channel controller communication path error logs 110B will be explained.

The own-channel controller communication path error log 110B comprises a processor error generation count 10D, a processor error table 10E, a driver circuit error generation count 10F, and a driver circuit error table 10G.

The processor error generation count 10D denotes the number of times an error is generated in the processor 120. Note that errors denoting each failure can be distinguished from one another using error numbers.

The processor error table 10E manages a generation time and detailed information for an error denoting a certain failure, for each error number, in relation to the processor 120, for example.

The driver circuit error generation count 10F denotes the number of times an error, which denotes failure generated in the driver circuit 140, is generated.

The driver circuit error table 10G manages a generation time and detailed information for an error denoting failure, for each error number, in relation to the driver circuit 140, for example.

(1-2) Failure Recovery Method in Redundant Storage System

(1-2-1) Overview of Failure Recovery Method

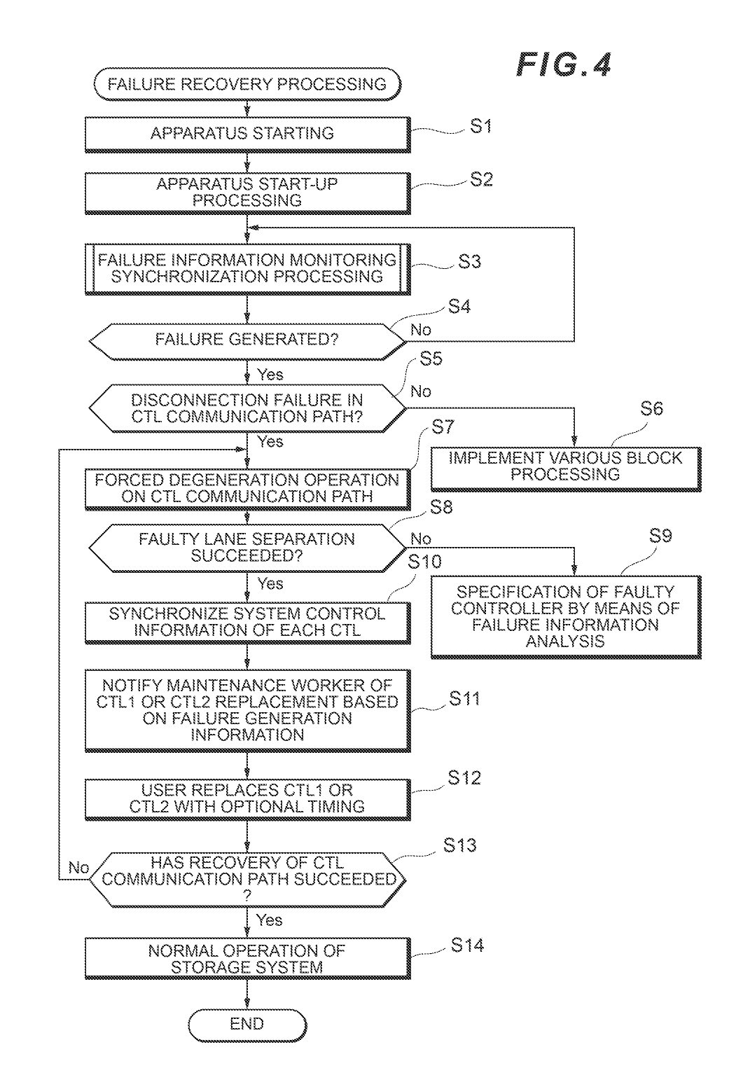

FIG. 4 shows an example of the failure recovery method. Note that, according to the first embodiment, while controller is shown abbreviated to ‘CTL’ in the drawings, the first controller 100 is also denoted as ‘CTL1’ and the second controller 200 is also denoted as ‘CTL2,’ for example.

Foremost, the redundant storage system is started up (step S1). As a result, the first controller 100 and the second controller 200 execute apparatus startup processing which includes initial configuration and the starting of the microprograms 110A and 210A (step S2). Note that, in the ensuing explanation, cases where there is no particular need to mention the second controller 200 are excluded, and the first controller 100 will mainly be explained.

Thereafter, the first controller 100 executes failure information monitoring synchronization processing in which the microprogram 110A gathers failure information through the control of the processor 120 (step S3). This failure information monitoring synchronization processing is executed on two occasions, for example. One such occasion when this failure information monitoring synchronization processing is executed is during the startup of the apparatus (hereinafter the startup time case), and another occasion is when this processing is executed at regular intervals during normal operation. Details of each sequence in these cases will be described hereinbelow.

In this failure information monitoring synchronization processing, the microprogram 110A collects error information which corresponds to an error denoting a certain failure and stores the error information in the error register 120A, and synchronizes this collected error information between the own controller (the first controller 100) and the other controller (the second controller 200).

In the first controller 100, the processor 120 refers to the error information of the error register 120A and determines whether failure has been generated based on the error information (step S4).

The microprogram 110A determines, under the control of the processor 120, whether there is a disconnection failure in the controller communication path 500 between the first controller 100 and the second controller 200 (step S5). The processor 120 implements various block processing when it is determined that there is no disconnection failure in the controller communication path 500 (step S6).

However, when it is determined that there is a disconnection failure in the controller communication path 500, the processor 120 implements a forced degeneration operation on the controller communication path 500 (step S7). In the forced degeneration operation, the microprogram 110A performs, under the control of the processor 120, a degeneration operation so that, among the plurality of lanes constituting the controller communication path, only the communication-capable lanes which remain unaffected by the failure are used. In the present embodiment, unused lanes which have been affected may also be referred to as ‘faulty lanes.’ Note that the operation extending from step S7 to step S13, which latter step will be described subsequently, corresponds to a microprogram operation for maintenance work.

The processor 120 then causes the microprogram 110A to determine whether the degeneration linkup has succeeded. More specifically, the microprogram 110A determines whether the faulty lane separation has succeeded (step S8). When the faulty lane separation has not succeeded, the microprogram 110A specifies the faulty controller by means of failure information analysis (step S9). Note that the first embodiment is devised so that, when implementing failure information analysis in this manner, the accuracy of specifying the block controller is improved by collecting this failure information, as will be described subsequently.

On the other hand, when the faulty lane separation has succeeded, the microprogram 110A synchronizes the system control information of each of the controllers 100 and 200 (step S10).

The microprogram 110A notifies a maintenance worker that the first controller 100 or the second controller 200 should be replaced via a PC 300, based on a failure generation information (step S11). At this time, when this processing is implemented by replacing the preceding controller, the processor 120 notifies the maintenance worker via the PC 300 that the controller that was replaced immediately beforehand should be replaced with another controller.

The maintenance worker, who has received this notification, replaces the first controller 100 or the second controller 200 with optional timing (step S12).

Upon receiving an interrupt to the effect that controller replacement has been implemented in this manner, the microprogram 110A determines whether recovery of the controller communication path 500 has succeeded (step S13). This determination is made so that subsequently controller maintenance work and controller recovery work are carried out by means of a forced degeneration operation on the controller communication path 500.

When it is determined that recovery of the controller communication path 500 has not succeeded, the microprogram 110A returns to the aforementioned step S7 and starts executing processing at this step, whereas When it is determined that the recovery of the controller communication path 500 has succeeded, the microprogram 110A causes the redundant storage system to operate normally (step S14).

(1-2-2) Relief Processing for Erroneous Specification of Block Controller

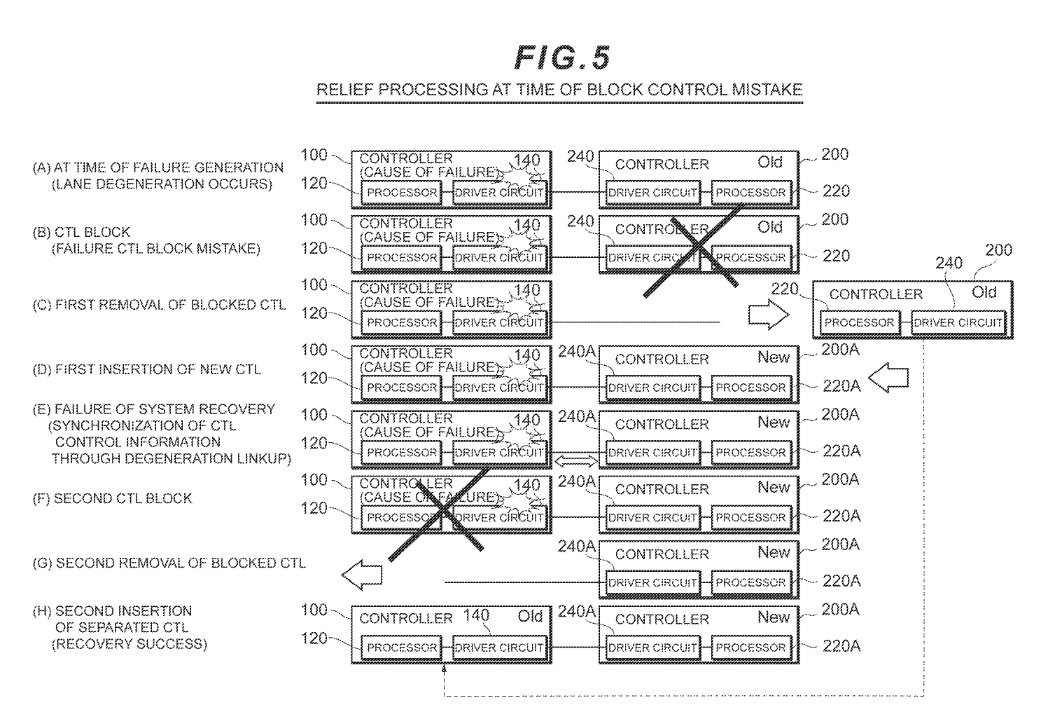

FIGS. 5A to 5H are each sequence charts which show an example of relief processing when a controller to be blocked has been erroneously specified. Note that, in the ensuing explanation, it is assumed that failure has been generated in the driver circuit 140 of the first controller 100.

As shown (A) in FIG. 5, when failure is generated, the lane between the first controller 100 and the second controller 200 is forcibly degenerated.

As shown (B) in FIG. 5, the controller to be blocked has been erroneously specified as the second controller 200 (corresponds to the controller with the x mark).

As shown (C) in FIG. 5, the second controller 200 is removed as a controller to be blocked. In reality, because failure has not been generated in the second controller 200, the second controller 200 is reinstalled according to the explanation with reference to (H) in FIG. 5 (described hereinbelow).

As shown (D) in FIG. 5, a third controller 200A is installed as the new controller (replacement at first time). Note that, in much the same way as the second controller 200, the third controller 200A comprises a driver circuit 240A which corresponds to the driver circuit 240 of the second controller 200, and a processor 220A which corresponds to the processor 220 of the second controller 200.

In this example, because the controller to be blocked was erroneous as explained above, as shown (E) in FIG. 5, even when the third controller 200A is installed, due to the effect of the first controller 100 in which failure was generated, the first controller 100 and third controller 200A cannot be synchronized by using the system control information between controllers through the degeneration linkup, and, in the end, system recovery fails.

As a result of the foregoing, controller replacement at second time is then implemented conversely. As shown (F) in FIG. 5, the first controller 100 is then made the target of a second controller replacement. That is, as shown (G) in FIG. 5, the first controller 100 is removed as the controller to be blocked.

Thus, as shown (H) in FIG. 5, the second controller 200, for example, is installed in place of the first controller 100 which was thus removed.

(1-2-3) Degeneration Linkup Upon Apparatus Startup

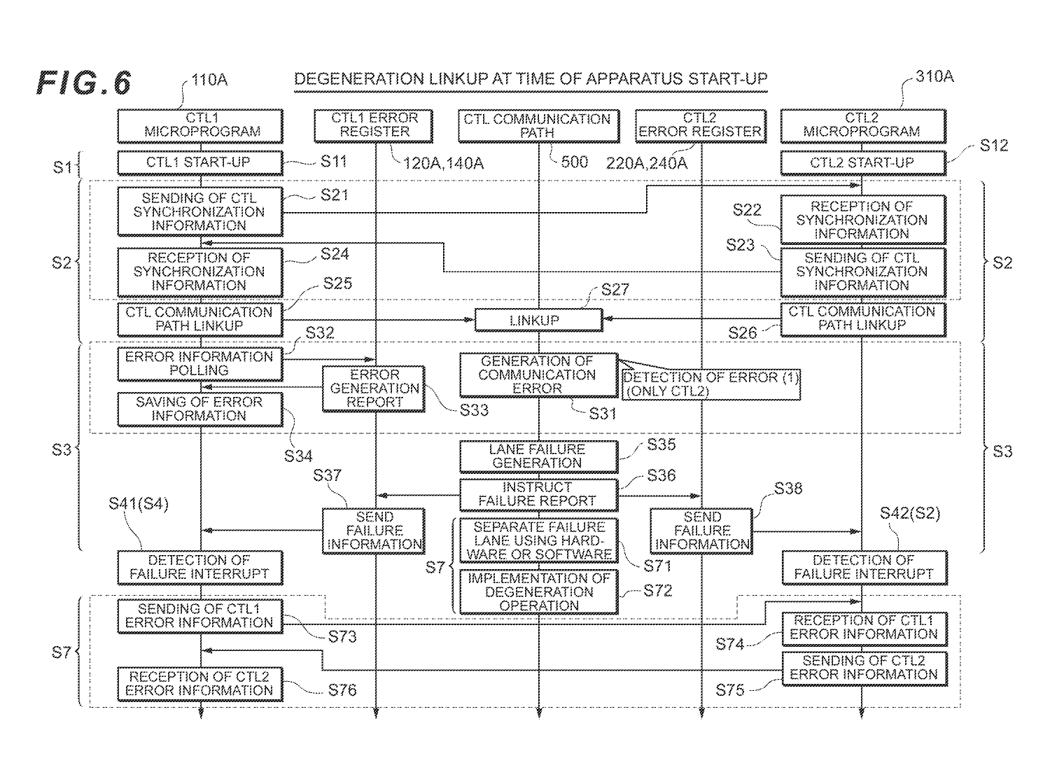

FIG. 6 is a sequence chart showing an example of degeneration linkup processing when the apparatus is operating. Note that when in the drawing, the reference signs are the same as the reference signs in FIG. 4 and so forth, this indicates identical processing.

In step S1, in the first controller 100, the microprogram 110A starts up the whole first controller 100 (step S11), whereas, in the second controller 200, the microprogram 210A stars up the whole second controller 200 (step S12).

In the next step S2, controller synchronization information is sent and received between the first controller 100 and the second controller 200. More specifically, in the first controller 100, the microprogram 110A sends controller synchronization information (corresponding to system control information and error information) for the second controller 200 (step S21), and in the second controller 200, the microprogram 210A receives this controller synchronization information (step S22). However, in the second controller 200, the microprogram 210A sends controller synchronization information to the first controller 100 (step S23) and, in the first controller 100, the microprogram 110A receives this controller synchronization information (step S24).

Moreover, in step S2, in the first controller 100, the microprogram 110A links up to the controller communication path 500 (step S25) and, in the second controller 200, the microprogram 210A links up to the controller communication path 500 (step 326). As a result, the linkup is completed for the controller communication path 500 (step S27).

In step S3 shown in FIG. 6, when failure such as a communication error in the controller communication path 500 is detected only in the second controller 200 (step S31), for example, in the first controller 100, by implementing polling of error information (step S32), the microprogram 110A receives an error generation report from the error register 120A of the processor 120 (step S33) and saves error information corresponding to this error generation report to the memory 110 as an error log of the controller communication path 500 (step S34).

On the other hand, when a lane failure is generated, for example, in step S3 (step 335), an instruction for a failure report is sent to the error register 120A of the first controller 100 and the error register 140A of the second controller 200 (step S36). Thereupon, this failure information is sent from the error register 120A of the first controller 100 to the microprogram 110A (step S37), and from the error register 220A of the second controller 200 to the microprogram 210A (step S38).

In step S4, in the first controller 100, the microprogram 110A detects a failure interrupt (step S41), whereas, in the second controller 200, the microprogram 210A detects a failure interrupt (step S42).

Thereafter, in step S7, a portion of the lanes in which a hardware or software failure has been generated is separated (step 371) and a degeneration operation is implemented (step S72).

Thereafter, in the first controller 100, the microprogram 110A sends error information to the second controller 200 (step S73) and, in the second controller 200, the microprogram 210A receives this error information (step S74). However, in the second controller 200, the microprogram 210A sends error information to the first controller 100 (step S75) and, in the first controller 100, the microprogram 110A receives this error information (step S76).

As a result, because failure information pertaining to before and after lane failure can be saved, valid data can be shared with failure mode analysis. In this example, a error is generated twice in the first controller 100, and an error is not generated in the second controller 200. Thereafter, even if failure is generated in the communication path between the plurality of controllers 100, 200, instead of one controller being blocked by being blindly singled out, it is possible to determine rationally which controller to block based on error information.

Thus, the first controller 100 and second controller 200 exchange error information with each other and complete degeneration linkup when an apparatus is started.

(1-2-4) Degeneration Linkup when the Apparatus is Operating

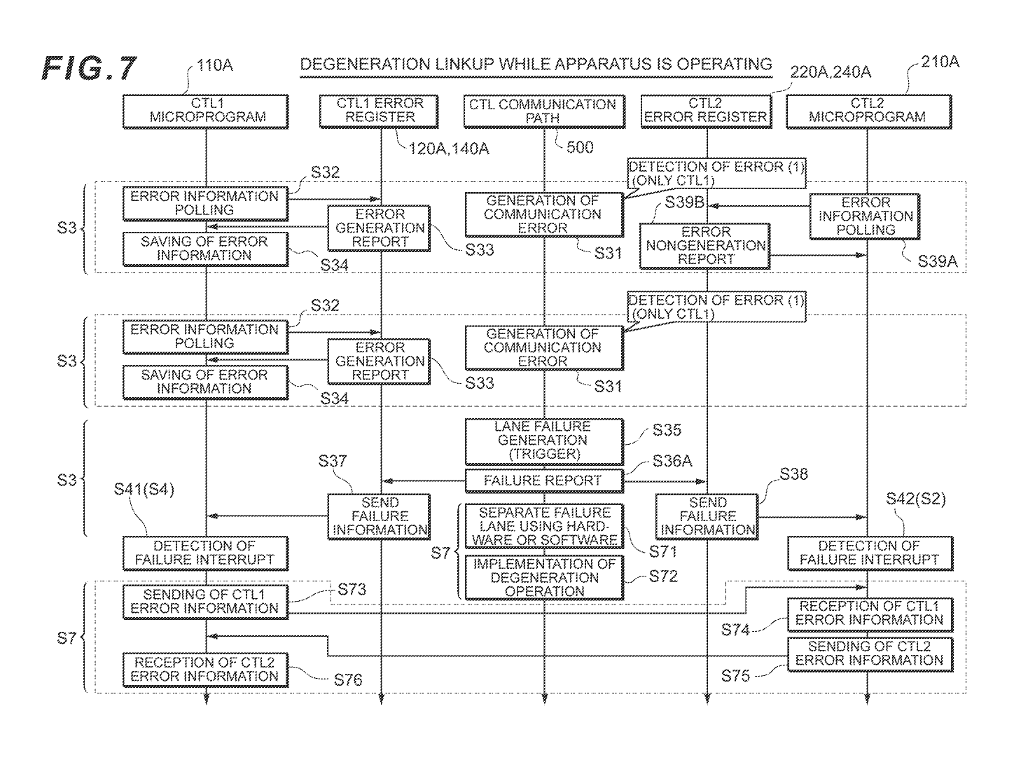

FIG. 7 is a sequence chart showing an example of degeneration linkup processing when the apparatus is operating. Note that, in the drawing, when the reference signs are the same as the reference signs shown in FIG. 4 and so forth, this indicates identical processing.

In step S3 shown in FIG. 7, when failure such as a communication error in the controller communication path 500 is detected only in the first controller 100 (step S31), for example, in the first controller 100, by implementing polling of error information (step S32), the microprogram 110A receives an error generation report from the error register 120A of the processor 120 (step S33) and saves error information corresponding to this error generation report to the memory 110 (step S34).

Thereafter, in step S3 shown in FIG. 7, in the second controller 200, by implementing polling of error information (S39A), the microprogram 210A receives an error nongeneration report from the error register 220A of the processor 220 (step 339B).

Moreover, in step S3 shown in FIG. 7, when failure such as a communication error in the controller communication path 500 is detected only in the second controller 200 (step S31), for example, in the first controller 100, by implementing polling of error information (step S32), the microprogram 110A receives an error generation report from the error register 120A of the processor 120 (step 333) and saves error information corresponding to this error generation report to the memory 110 as an error log of the controller communication path 500 (step S34).

However, in step S3, if lane failure is generated, for example (step S35), a failure report is made for the error register 120A of the first controller 100 and the error register 220A of the second controller 200 (step 336A). Thereupon, this failure information is sent from the error register 120A of the first controller 100 to the microprogram 110A (step S37), and from the error register 220A of the second controller 200 to the microprogram 210A (step S38).

In step S4, in the first controller 100, the microprogram 110A detects a failure interrupt (step S41), whereas, in the second controller 200, the microprogram 210A detects a failure interrupt (step S42).

Thereafter, in step S7, a portion of the lanes in which a hardware or software failure has been generated is separated (step S71) and a degeneration operation is implemented (step S72).

Thereafter, in the first controller 100, the microprogram 110A sends error information to the second controller 200 (step S73) and, in the second controller 200, the microprogram 210A receives this error information (step S74). However, in the second controller 200, the microprogram 210A sends error information to the first controller 100 (step S75) and, in the first controller 100, the microprogram 110A receives this error information (step S76).

Thus, the first controller 100 and second controller 200 exchange error information with each other and complete degeneration linkup while an apparatus is operating.

According to the first embodiment as explained in the foregoing, even if a controller to be blocked is erroneously determined, this controller can be replaced once again while the redundant storage system is online, without stopping the redundant storage system. Moreover, conversely, even if a degeneration operation cannot be implemented, it is possible to make a rational determination of the controller which is to be blocked based on failure information that has been generated since the apparatus started operating. Accordingly, in comparison with a case where the controller to be blocked is blocked by being blindly pinpointed, it is possible to improve the reliability of accurately specifying which controller should rightfully be blocked.

In other words, according to this embodiment, it is possible to avoid a so-called offline replacement of a controller, which harms the availability of the system. Moreover, by maintaining the operation of the system by means of bus degeneration of a plurality of lanes constituting the controller communication path 500, more failure information can be gathered. As a result, according to this embodiment, the accuracy of failure mode analysis improves, and it is possible to reduce the possibility of implementing offline controller replacement. The foregoing is particularly effective in the case of a failure mode, where lane failure is prone to gradual expansion.

### (2) Second Embodiment

The redundant storage system according to the second embodiment is configured in much the same way as the redundant storage system according to the first embodiment and executes the same operations, and hence in the ensuring explanation, the points of difference between the two redundant storage systems will be explained.

(2-1) Features of the Second Embodiment

The redundant storage system according to the second embodiment differs from the first embodiment in that the first controller 100 and the second controller 200 each execute faulty controller specification processing. Specific details are explained hereinbelow.

(2-2) Faulty Controller Specification Processing

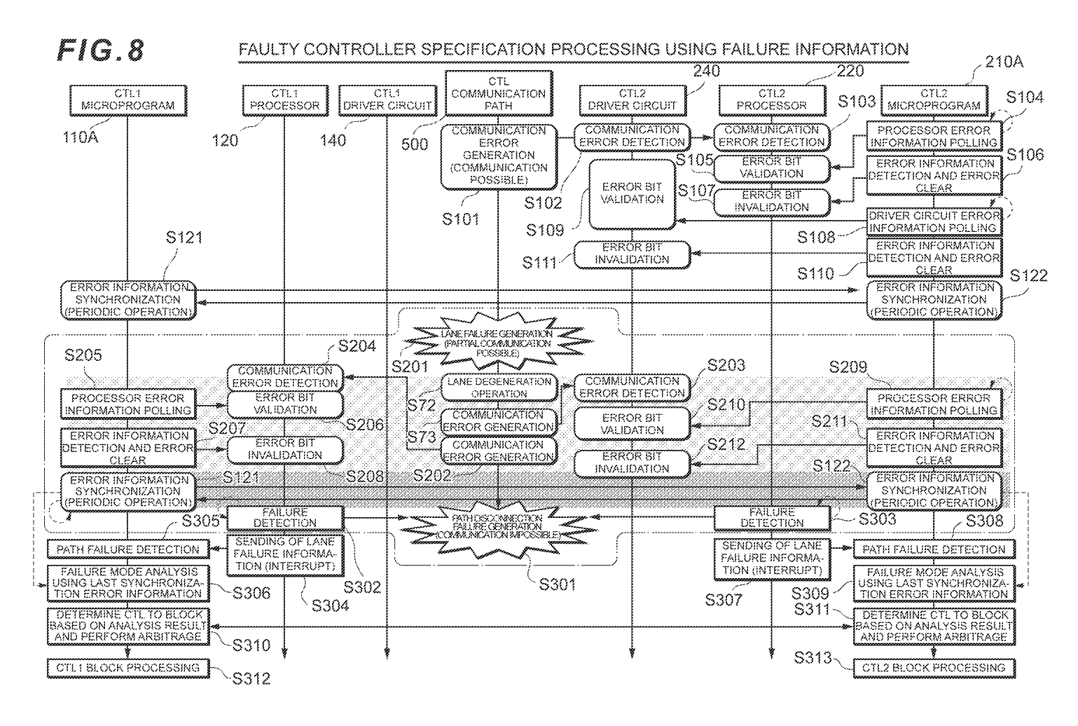

FIG. 8 is a sequence chart showing an example of faulty controller specification processing using failure information. Note that, in the drawing, when the reference signs are the same as the reference signs in FIG. 4 and the like, this indicates the same processing.

When communication is possible in the controller communication path 500 yet a communication error is generated (step S101), in the second controller 200, the driver circuit 240 detects a communication error (step S102) and the processor 220 detects this communication error (step S103).

In the second controller 200, the microprogram 210A implements periodic processor error polling (step S104) and validates an error bit in the error register 220A of the processor 220 (S105).

In the second controller 200, the microprogram 210A implements error information detection and error clearing (step S106) and invalidates the error bit (step S107).

In the second controller 200, the microprogram 210A implements periodic driver circuit error information polling (step S108) and validates the error bit (S109).

In the second controller 200, the microprogram 210A implements error information detection and error clearing (step S110) and invalidates the error bit (step S111).

Thereafter, error information is synchronized periodically between the microprogram 110A of the first controller 100 and the microprogram 210A of the second controller 200 (steps S121, S122).

Meanwhile, when communication is partially possible but lane failure is generated (step S201), a lane degeneration operation is implemented in the controller communication path 500 (step 372).

As a result of this lane failure, a communication error is generated between the controller communication path 500 and the second controller 200 (step S202), and, in the first controller 100, the processor 120 detects this communication error (step S203). As a result, the controller failure information pertaining to after the lane failure was generated can also be used as analysis information.

However, as a result of this lane failure, a communication error is generated between the controller communication path 500 and the first controller 100 (step S202), and in the second controller 200, the processor 220 detects this communication error (step S204). As a result, the controller failure information pertaining to after the lane failure was generated can also be used as analysis information.

In the first controller 100, the processor 120 implements processor error information polling (step S205) and validates an error bit in the error register 120A of the processor 120 (S206).

Thereafter, in the first controller 100, the microprogram 110A implements error information detection and error clearing (step 3207) and invalidates the error bit in the error register 120A of the processor 120 (step S208).

Meanwhile, in the second controller 200, the microprogram 210A implements processor error information polling (step S209) and validates the error bit in the error register 220A of the driver circuit 240 (step S210).

Moreover, in the second controller 200, the microprogram 210A implements error information detection and error clearing (step S211) and invalidates the error bit (step S212).

Thereafter, error information is synchronized as a result of being exchanged periodically between the microprogram 110A of the first controller 100 and the microprogram 210A of the second controller 200 via the controller communication path 500 (steps S121, S122). As a result, information pertaining to after failure was generated can also be shared between the first controller 100 and second controller 200.

Meanwhile, when a path disconnection failure is generated in the controller communication path 500 and communication is not possible (step S301), in the first controller 100, the processor 120 detects this failure by executing periodic detection processing (step S302), whereas, in the second controller 200, the processor 220 detects this failure by executing periodic detection processing (step S303).

In the first controller 100, the processor 120 sends the lane failure information to the microprogram 110A in interrupt processing (step S304) As a result, the microprogram 110A detects path failure (step S305) and analyzes failure mode based on the error information of the last synchronization (step S306).

Meanwhile, in the second controller 200, the processor 220 sends the lane failure information to the microprogram 210A in interrupt processing (step S307). As a result, the microprogram 210A detects path failure (step S308) and analyzes failure mode based on the error information of the last synchronization (step S309). As a result, analysis can be implemented based on the largest possible amount of gathered error information.

In the first controller 100, the microprogram 110A determines the controller to be blocked according to the analysis result and performs arbitration on the second controller 200 (step S310).

Meanwhile, in the second controller 200, the microprogram 210A determines the controller to be blocked according to the analysis result and performs arbitration on the first controller 100 (step S311).

As a result of the foregoing arbitration, the first controller 100 is blocked according to the above analysis result (step S312), and the second controller 200 is blocked (step S313).

As explained in the foregoing, according to the second embodiment, by executing faulty controller specification processing, not only is it possible to use controller failure information after lane failure has been generated, as analysis information, which was conventionally impossible, but additionally the information after failure was generated can also be shared, and although conventionally impossible, the analysis can be implemented based on the largest possible amount of gathered error information.

### (3) Other Embodiments

The foregoing embodiments are examples serving to explain the present invention, but the spirit of the present invention is not limited to these embodiments alone. The present invention can be embodied in various forms without departing from the spirit of the invention. For example, although the processing of the various programs was explained as sequential processing in the foregoing embodiments, the present invention is not limited in any way thereto. Therefore, provided that there are no inconsistencies in the processing result, the configuration may be such that the order of the processing is switched, or parallel processing is executed. Moreover, the program that comprises each processing block in the foregoing embodiments could also be in a computer-readable form which is stored in a non-temporary storage medium, for example.

### REFERENCE SIGNS LIST

100 . . . controller, 110 . . . memory, 110A . . . microprogram, 120 . . . processor, 140 . . . driver circuit, 210 . . . memory, 210A . . . microprogram, 220 . . . processor, 240 . . . driver circuit, 200 . . . controller, 300 . . . PC, 500 . . . controller communication path.

1. A redundant storage system, comprising:
a plurality of controllers which control each of a plurality of storage apparatuses, the plurality of controllers being connected via a controller communication path,
wherein the plurality of controllers each comprise:
a failure information gathering unit which gathers failure information relating to failure generated in the plurality of controllers or in any part between the plurality of controllers;
an information synchronization unit which causes the failure information gathered by the failure information gathering unit and system control information relating to control of the plurality of controllers to be synchronized and shared between the plurality of controllers;
a block determination unit which performs a block determination of which controller among the plurality of controllers is to be blocked when it is detected that failure has been generated in the plurality of controllers or in any part between the plurality of controllers based on the failure information which was last synchronized by the information synchronization unit;
a degeneration control unit which continuously performs by degenerating communication between the plurality of controllers by using a portion of the controller communication path even when it is determined that one controller among the plurality of controllers is to be blocked; and
a resynchronization instruction unit which, when it is determined as a result of the block determination that the one controller is to be blocked but the block determination is erroneous, causes the information synchronization unit to synchronize the new controller to the reinstalled one controller by using the most recent system control information which was last synchronized, in response to the new controller being installed in place of the one controller.

2. The redundancy storage system according to claim 1,
wherein the plurality of controllers each comprise a memory capable of storing own failure information and partner failure information which are gathered by the failure information gathering unit, and the system control information, and
wherein the degeneration control unit is able to continuously perform by degenerating communication between the plurality of controllers by using at least a portion of lanes capable of communication among the plurality of lanes even when it is determined that one controller among the plurality of controllers is to be blocked, and is able to allow control of synchronization between the own failure information and the partner failure information by the information synchronization unit.

3. The redundancy storage system according to claim 1,
wherein the controller communication path is configured from a plurality of lanes, and wherein the degeneration control unit continuously performs by degenerating communication between the plurality of controllers by using at least a portion of lanes capable of communication among the plurality of lanes even when it is determined that one controller among the plurality of controllers is to be blocked.

4. The redundancy storage system according to claim 1,
wherein the plurality of controllers comprise, as the part where failure can be generated, a driver circuit which performs communication between the plurality of controllers.

5. The redundancy storage system according to claim 4,
wherein the resynchronization instruction unit causes the information synchronization unit to synchronize the new controller to the reinstalled one controller by using the most recent system control information which was last synchronized by using at least a portion of lanes capable of communication during degeneration control by the degeneration control unit.

6. A failure recovery method in a redundant storage system which comprises a plurality of controllers which control each of a plurality of storage apparatuses, the plurality of controllers being connected via a controller communication path, comprising:
a failure information gathering step in which the plurality of controllers gather failure information relating to failure generated in the plurality of controllers or in any part between the plurality of controllers;
an information synchronization step in which the plurality of controllers cause the failure information gathered in the failure information gathering step and system control information relating to control of the plurality of controllers to be synchronized and shared between the plurality of controllers;
a block determination step in which one controller among the plurality of controllers performs a block determination of which controller among the plurality of controllers is to be blocked when it is detected that failure has been generated in the plurality of controllers or in any part between the plurality of controllers based on the failure information which was last synchronized in the information synchronization step;
a degeneration control step in which the plurality of controllers continuously perform by degenerating communication between the plurality of controllers by using a portion of the controller communication path even when it is determined that one controller among the plurality of controllers is to be blocked; and
a resynchronization instruction step in which, when it is determined as a result of the block determination that the one controller is to be blocked but the block determination is erroneous, one controller among the plurality of controllers causes the new controller to be synchronized to the reinstalled one controller by using the most recent system control information which was last synchronized in the information synchronization step, in response to the new controller being installed in place of the one controller.

7. The failure recovery method in a redundant storage system according to claim 6,
wherein the plurality of controllers each comprise a memory capable of storing own failure information and partner failure information which are gathered in the failure information gathering step, and the system control information, and
wherein, in the degeneration control step, the plurality of controllers are able to continuously perform by degenerating communication between the plurality of controllers by using at least a portion of lanes capable of communication among the plurality of lanes even when it is determined that one controller among the plurality of controllers is to be blocked, and control of synchronization between the own failure information and the partner failure information is allowed in the information synchronization step.

8. The failure recovery method in a redundant storage system according to claim 6, wherein the controller communication path is configured from a plurality of lanes, and wherein, in the degeneration control step, the plurality of controllers continuously perform by degenerating communication between the plurality of controllers by using at least a portion of lanes capable of communication among the plurality of lanes even when it is determined that one controller among the plurality of controllers is to be blocked.

9. The failure recovery method in a redundant storage system according to claim 6, wherein the plurality of controllers comprise, as the part where failure can be generated, a driver circuit which performs communication between the plurality of controllers.

10. The failure recovery method in a redundant storage system according to claim 9, wherein, in the resynchronization instruction step, one controller among the plurality of controllers synchronizes the new controller to the reinstalled one controller by using the most recent system control information which was last synchronized by using at least a portion of lanes capable of communication during degeneration control in the degeneration control step.
